(19) United States
(12) Patent Application Publication
(10) Pub. No.: US 2026/0156074 A1
(43) Pub. Date: Jun. 4, 2026

(54) SYSTEMS AND METHODS FOR INTELLIGENT NETWORK SEGMENT ROUTING

(71) Applicant: Verizon Patent and Licensing Inc., Basking Ridge, NJ (US)

(72) Inventors: Sanjay Vyas, Hyderabad (IN); Max Sebastian, Tampa, FL (US); Sireesh C. Mutharaju, Hyderabad (IN); Vasu Sharma, Hyderabad (IN); Ramesh Kare, Hyderabad (IN)

(21) Appl. No.: 18/964,808

(22) Filed: Dec. 2, 2024

(51) Int. Cl. H04L 45/00

(52) U.S. Cl. CPC H04L 45/70; H04L 45/566

(57) ABSTRACT

Systems and methods described herein provide intelligent network segment routing. A method performed in a network of virtual routers includes designating a unique node identifier (ID) for each routing node in a network and designating a segment ID for each link between two of the routing nodes. Each segment ID is based on a first node ID and an adjacent second node ID for each link. The method also includes obtaining real-time link utilization data for each of the links, assigning a segment score to each of the links based on the real-time link utilization data and the segment ID, and routing packets through the network based on the segment scores and the node IDs.

### BACKGROUND

Multiprotocol label switching (MPLS) is a connection-oriented routing technique used in data networks for directing data from one node to a next node in the network based on path labels rather than network addresses (as used, for example, in Internet Protocol (IP) traffic routing). Use of the path labels, instead of network addresses, avoids complex routing table lookups. For example, MPLS forwards packets based on a fixed-length, short label that corresponds to a label switched path (LSP) that has been previously established via signaling between an ingress and egress node in the network, and via signaling between intermediate nodes on the path between the ingress and egress nodes. Forwarding attributes (e.g., bandwidth) for the virtual link (i.e., LPS) are typically negotiated during the connection set-up signaling. MPLS, therefore, introduces significant signaling overhead to establish the label switched path.

### BRIEF DESCRIPTION OF THE DRAWINGS

FIG. 1 is a diagram that depicts an example network environment in which systems and methods described herein may be implemented;

FIG. 2 is a schematic illustrating segment routing (SR) in a simplified network portion, according to an implementation;

FIG. 3 is a diagram illustrating a segment identifier (SID) assignment process for a virtual router, according to an implementation;

FIG. 4 is a block diagram illustrating exemplary components of a link analytics platform;

FIG. 5 is a diagram illustrating an implementation of segment scoring, according to an implementation;

FIG. 6 is a diagram illustrating a routing process based on segment scoring in a network portion, according to an implementation;

FIG. 7 is a diagram illustrating a path determining process based on path scoring, according to an implementation;

FIG. 8 is a diagram illustrating a prefix-based routing process based on segment scoring, according to another implementation;

FIG. 9 is a flow diagram illustrating an exemplary process for configuring a node for intelligent segment routing;

FIG. 10 is a flow diagram illustrating an exemplary process for performing intelligent network segment routing; and

FIG. 11 is a block diagram of example components of a device, according to an implementation described herein.

### DETAILED DESCRIPTION

The following detailed description refers to the accompanying drawings. The same reference numbers in different drawings may identify the same or similar elements. Also, the following detailed description does not limit the invention.

Segment routing (SR) is a variant of source routing in which network state information is removed from intermediate routers and path state information is placed into the packet headers for use by the intermediate routers. When a packet arrives at a SR ingress router, the ingress router subjects the packet to a forwarding policy that identifies a SR path from the ingress router to the packet's destination. The SR path includes a list of segments to connect the ingress router to an egress router. In segment routing, a single SR segment includes an instruction that causes a packet to traverse a section of the network topology. The list of segments in the SR path that may be ordered in some embodiments, therefore, includes a sequence of multiple instructions that cause the packet to traverse multiple segments in an order determined by the ordered list of segments.

Current network traffic engineering methods face significant challenges in efficiently managing link utilization within SR environments. More particularly, there is a need for systems and methods that can dynamically respond to varying network conditions, such as congestion and underutilization, without maintaining extensive state information across multiple routers. Traditional approaches often require complex state maintenance and coordination among numerous Label Switched Routers (LSRs), leading to increased overhead and reduced scalability.

Systems and methods described herein address these and other issues by providing a solution that leverages link utilization measurements received at a Label Edge Router (LER) to detect and respond to network conditions. The systems and methods maintain the state of a SR tunnel at the LER using a label stack that includes node Segment IDs (SIDs) and adjacency SIDs, thereby simplifying state management and enhancing the efficiency of traffic engineering in SR networks.

According to one implementation, an intelligent network segment routing system is provided. A method performed in a network of virtual routers includes designating a unique node identifier (ID) for each routing node in a network and designating a SID for each link between two of the nodes. Each SID is based on a first node ID and an adjacent node ID for each link. The method also includes obtaining real-time link utilization data for each of the links, assigning a segment score to each of the links based on the real-time link utilization data and the segment ID, and routing packets through the network based on the segment scores and the node IDs.

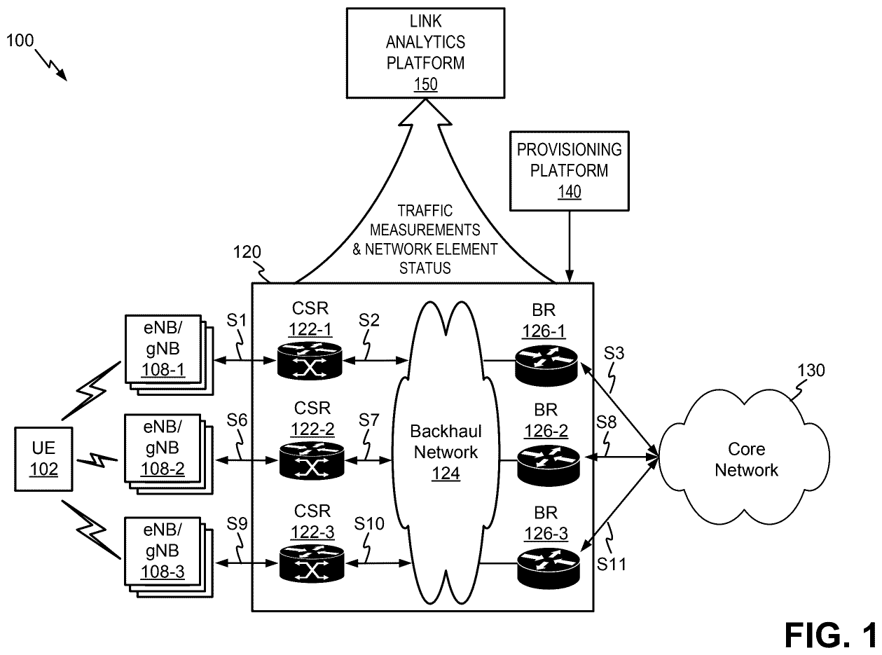

FIG. 1 is a diagram of an exemplary network environment 100 in which systems and methods described herein may be implemented. As shown in FIG. 1, network environment 100 may include user equipment (UE) device 102 (as used herein, collectively referred to as “UE devices 102” and individually as “UE device 102-x”), wireless access stations 108 (shown as “eNB/gNB 108” in FIG. 1, and collectively referred to as “wireless access stations 108” and individually as “wireless access station 108-x”), an intermediary network 120, a core network 130, a provisioning platform 140, and a link analytics platform 150. Intermediary network 120 may include cell site routers (CSR) 122 (collectively referred to as “CSR 122” and individually as “CSR 122-x”), one or more backhaul networks 124, backhaul routers (BR) 126 (collectively referred to as “BRs 126” and individually as “BR 126-x”). End-to-end communications through network elements of environment 100 may be conducted through segments, such as segments S1 through S11, as indicated in FIG. 1.

UE device 102 may include any device with long-range (e.g., cellular or mobile wireless network) wireless communication functionality. For example, UE device 110 may include a handheld wireless communication device (e.g., a mobile phone, a smart phone, etc.); a wearable computer device; a telematics system in a vehicle; a portable computer; a customer premises equipment (CPE) device, such as a fixed wireless access (FWA) device; an automated guided vehicle (AGV); a portable gaming system; an Internet of Things (IoT) device; and/or any other type of computer device with wireless communication capabilities. In some implementations, UE device 102 may communicate using machine-to-machine (M2M) communication, such as machine-type communication (MTC), and/or another type of M2M communication.

Wireless access stations 108 may service a set of UE devices 102. Wireless access station 108 may include a Fifth Generation (5G) base station (e.g., a gNB) or a Fourth Generation (4G) base station (e.g., an eNB) that includes one or more radio frequency (RF) transceivers configured to send and receive wireless signals to/from UE device 102. For example, wireless access station 108-1 may service some UE devices 102 when the UE devices 102 are located within the geographic area serviced by wireless access station 108-1, while other UE devices 102 may be serviced by another wireless access station 108 when the UE devices 102 are located within the geographic area serviced by the other wireless access station 108. According to an implementation, a wireless access station 108 may include a gNB or its equivalent with multiple distributed components, such as a central unit (CU), a distributed unit (DU), a radio unit (RU), a remote radio unit (RRU), or another type of component. Wireless access station 108 may connect to core network 130 via devices in intermediary network 120, as described further herein.

Each wireless access station 108 may interface with the core network 130 through intermediary network 120. Intermediary network 120 may be functionally coupled to a plurality of wireless access stations 108. According to an embodiment, one or more wireless access stations 108, which may be functionally interconnected to each other and can also be separately connected to intermediary network 120, may be referred to as a Radio Access Network (RAN), such as a New Radio RAN or the evolved Universal Mobile Telecommunications Service (UMTS) Terrestrial RAN (eUTRAN). Intermediary network 120 may include multiple CSRs 122, a backhaul network 124, and BRs 126.

CSR 122 may manage the connection between wireless access station 108 and backhaul network 124. CSR 122 may also be used to manage connections with legacy base stations which may be present at the same site as wireless access stations 108. Typically, one CSR 122 may be used per wireless access stations 108 to connect with backhaul network 124. Backhaul network 124 may interface with a plurality of wireless access stations 108 and serve as an aggregation point for a RAN to connect with the core network 130. Each wireless access station 108 may connect through a separate CSR 122. Backhaul network 124 may be configured to support high bandwidth transport and can include wavelength-division multiplexing (WDM) optical networking components. BR 126 may include one or more routers or other network devices that provide an entry and/or an exit to and from intermediary network 120.

Core network 130 may manage communication sessions for UE devices 102. Core network 130 may provide mobility management, session management, authentication, and packet transport, to support wireless communication services for UE devices 102. Core network 130 may further provide access to a data network (not shown) or other UE devices 102 via another intermediate network 120. Core network 130 may be compatible with known wireless standards which may include, for example, 3GPP 5G (non-standalone (NSA) and standalone (SA)), Long-Term Evolution (LTE), LTE Advanced, Global System for Mobile Communications (GSM), etc. Core network 130 may include various types of network devices, which may implement different network functions described further herein.

Provisioning platform 140 may include one or more computing devices and/or network devices to enable configuring of virtual network equipment, such as virtual routers used in intermediate network 120. As described further herein, provisioning platform 140 may enable assignment of node IDs and/or SIDs to virtual routers used in intelligent network segment routing.

Link analytics platform 150 may include one or more computing devices and/or network devices to measure traffic data throughput for the entire network at a granular level, which may include measuring traffic at selected segments (e.g., any or all of segments S1 through S11 of FIG. 1) and/or network elements. Link analytics platform 150 may be a distributed component located, for example, within different data centers of a provider network. As described further herein, in one implementation, link analytics platform 150 may include an artificial intelligence/machine learning (AI/ML) component to model network segments for routing path selection.

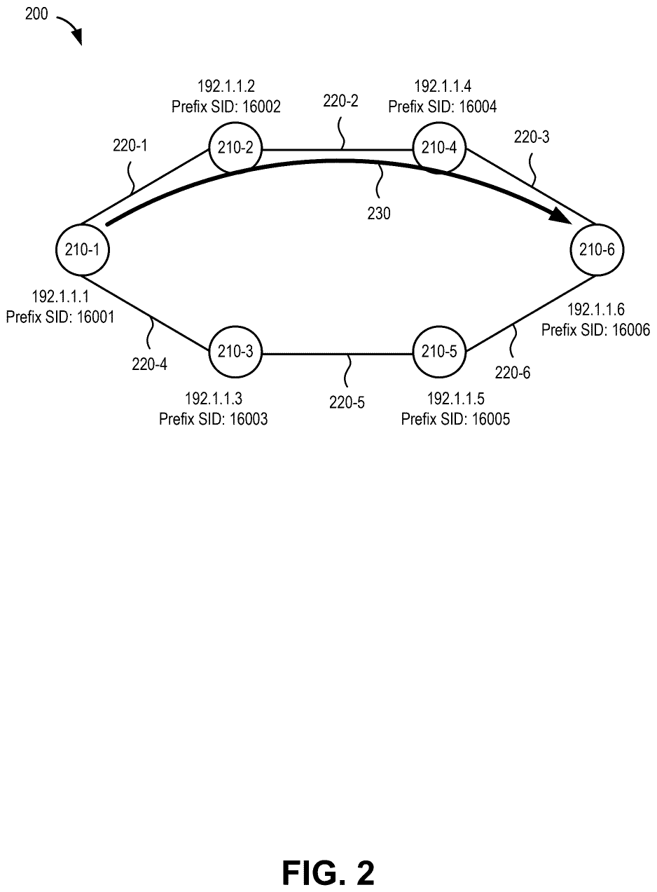

FIG. 2 is a schematic illustrating a simplified network portion 200 of environment 100 where SR may be implemented. Network portion 200 may implement software-defined networking (SDN) with multiple virtual LSRs. Segment routing may be described as a type of source routing technology where the source (i.e., a node) can define the path that a packet will take through the network. According to implementations described herein, segment routing may divide a network into multiple segments and assign a SID to each segment and forwarding node. The segments and nodes may be sequentially arranged into a segment list to form a forwarding path. For example, SR may be divided into two types based on the forwarding plane. Segment Routing MPLS (SR MPLS) is based on the MPLS forwarding plane, whereas Segment Routing IPv6 (SRv6) is based on the IPv6 forwarding plane. Systems and methods described herein may be applicable to either SR MPLS or SRv6.

As described herein, in one implementation, intelligent network segment routing ensures network segmentation integrity by distributing routes with segment identification, applying policies for specific links (e.g., virtual private network (VPN) segments), and handling encapsulation/decapsulation using an SID (e.g., an Ethernet Virtual Local Area Network (VLAN) ID) to denote the VPN segment or subnetwork. This encapsulated segmentation data within a packet determines the routing and forwarding table used for the next hop. Messages received through a common interface are processed by a universal routing instance (e.g., nodes 210) which then selects the appropriate virtual routing and forwarding (VRF) table based on the VLAN ID or segment identifier representative of the subnetwork (e.g., segment). Thus, the routing instance processes incoming packets by removing the VLAN ID, then retrieves the matching VRF and policy ID using the VLAN ID. This approach allows a single routing instance to manage multiple segments (subnetworks) connected to a specific forwarding device (e.g., VPN router) through a common subinterface.

As shown in FIG. 2, a network portion 200, may include multiple forwarding nodes 210-1 through 210-6 (referred to collectively or generically as forwarding node 210) connected by segments (e.g., fiber/ethernet VLAN links) 220 (referred to collectively or generically as segments 220). Each node 210 may include, for example, virtual routers configured on a multi-service hardware platform. Node 210-1 may be a label edge router (LER). The LER may reside at an edge of network portion 200 to send/receive traffic to/from UE devices 102 or applications. The LER may forward received packets towards a destination via intermediate nodes (e.g., LSRs, such as nodes 210-2 through 210-6) along one or more established LSPs, or, in the case of a link failure, along one or more bypass LSPs.

Each segment 220 may be identified by a SID. The SID may be a numerical value taken from each router's available label number range. Interior gateway protocol (IGP) distributes two types of segments: prefix segments and adjacency segments. The SID may include at least a prefix SID (e.g., a unique identifier of a forwarding node, also referred to herein as a “node ID”) and an adj-SID (e.g., a unique identifier of an adjacent forwarding node connected by the link). Thus, each virtual router (node) and each link (adjacency) has an associated SID. Each node 210 make and model may have a numerical range of, for example, 100,000 for the Segment Routing Global Block (SRGB). According to an implementation, a SID may have a numerical range from 0 to 99999 with each business unit, for example.

In the illustration of FIG. 2, a routing path 230 from node 210-1 to node 210-6 via nodes 210-2 and 210-4 may be defined at node 210-1 (e.g., the LER) using prefix SIDs 16002, 16004, and 16006. In one implementation, adjacency segment-based and node segment-based forwarding paths may be used, where the prefix SIDs may be included in a packet header to direct routing of the packet through the network. In another implementation, a prefix segment-based forwarding path may be used, where the prefix SID of an end node may be used to direct packet forwarding.

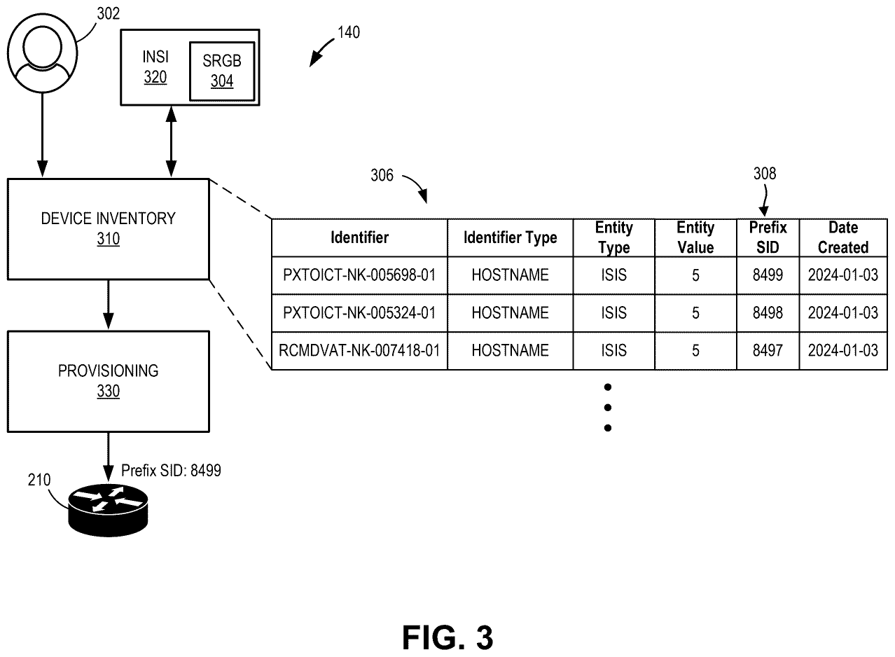

FIG. 3 illustrates an SID assignment process for a virtual router that may be performed by provisioning platform 140. As shown in FIG. 3, a network engineer 302 (i.e., a person) may configure a new virtual network element (i.e., a router) for a network using a device inventory platform 310. The network engineer 302 may define, for example, a hierarchy and links for the new router. As part of the configuration processes, a prefix SID may be assigned. The prefix SID may be assigned, for example, from the next available number from a Segment Routing Global Block (SRGB) 304 managed by IP and Network Segment Inventory (INSI) system 320. For example, device inventory platform 310 may use an application programming interface (API) call to INSI system 320 to trigger INSI system 310 to assign a next available prefix SID for the new virtual network element. Although shown as part of INSI 320, in other implementations SRGB 304 may be included as a separate data structure and implemented in another device or element.

The router configuration may be stored as a record in a data structure 306 (e.g., a table, database, flat file, etc.). Each record in data structure 306 may associate a router configuration with a particular prefix SID, as shown in prefix SID field 308, as well as an identifier type, entity type, entity value, and date. Once created, the router configuration with the record (e.g., including the assigned prefix SID) may be provided, for example, to a provisioning system 330.

Provisioning system 330 may use information from data structure 306 to perform activation of a new forwarding node 210 on the network (e.g., network portion 200). The provisioned forwarding node 210 may then be included in routing paths and routing decisions for intelligent routing through network portion 200 using the assigned prefix SID, as described further herein.

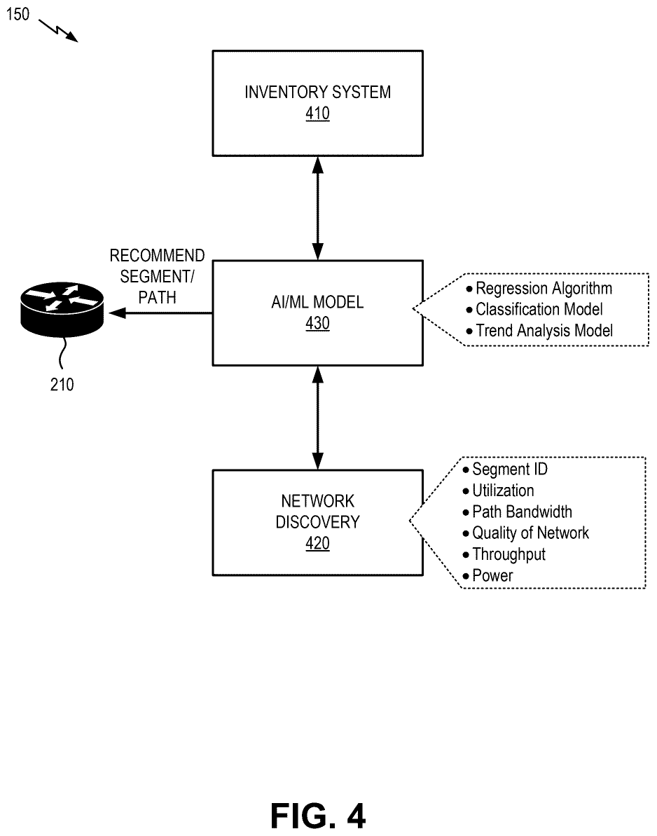

FIG. 4 is a block diagram illustrating components of link analytics platform 150. As shown in FIG. 4, link analytics platform 150 may include an inventory system 410, a network discovery system 420, and an AI/ML model 430.

Inventory system 410 may track inventory of network elements in network portion 200, such as forwarding nodes 210 and other virtual network functions. Inventory system 410 may include, for example, an active and available inventory (AAI) function. In one implementation, inventory system 410 receives inventory listings from provisioning system 330 and monitors/updates parameters of individual network functions (e.g., forwarding nodes 210) and links (e.g., segments 220).

Network discovery system 420 may collect network parameters for inventoried network elements. According to implementations described herein, network discovery system 420 may collect network traffic data and provide data updates in real time (e.g., accounting for normal compute processing time, without delay or asynchronism). In other implementations, network discovery system 420 may collect network data and provide periodic data updates. Traffic data may be measured at any element (e.g., nodes 210) and/or segment (e.g., segments 220) and subsequently reported to inventory system 410 and/or AI/ML model 430.

As illustrated in FIG. 4, network discovery system 420 may collect, among other parameters, a segment ID, utilization level, path bandwidth, a quality of network, throughput, and power for nodes 210. Segment ID may include the segment ID for each monitored segment 220 (e.g., including a prefix SID and an adj-SID). A utilization level may include a utilization key performance indicator (KPI) associated with a segment ID, such as a resource block utilization rate, an average processor load, a memory utilization rate, a bandwidth utilization rate, etc. Path bandwidth may include bandwidth measurements associated with a segment ID, such as a configured bandwidth (e.g., in gigabytes), a currently available bandwidth, and/or a currently utilized bandwidth for one or more links (e.g., segment 220). Quality of network information may include KPIs for a link/path, such as latency KPI values, throughput KPI values, jitter KPI values, dropped packet, congestion indicators, alarms, etc. Throughput may include measurement of downlink average throughput, downlink maximum throughput, uplink average throughput, uplink maximum throughput, etc. Power may include signal power (e.g., in milliwatts (mW)) used by a forwarding node 210 to transmit optical signals over a segment 220 associated with a SID.

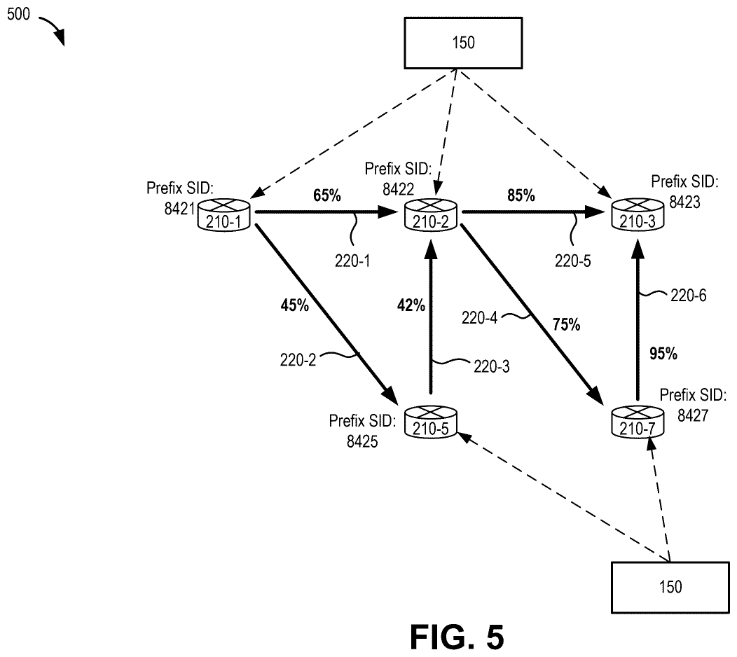

AI/ML model 430 may include an AI/ML model that may provide or support one or multiple sub-services for intelligent network segment routing, as described herein. AI/ML model 430 may apply, for example, one or more of a regression algorithm, a classification model, and/or a trend analysis model to the real-time link utilization data received from network discovery system 420. In one implementation, AI/ML model 430 may interpret network traffic data from network discovery system 420 and score or rank segments 220 for route selection. In another implementation, measurements at segments 220 and/or forwarding nodes 210 may be combined along a path, so that a path may be identified and scored end-to-end across an entire network or network portion based on the real-time measured traffic data. As shown in FIG. 4, AI/ML model 430 may provide a recommended segment 220 or path to a forwarding node 210 based on the assigned segment scores, as describe further below in connection with FIGS. 5-8, for example.

According to an exemplary embodiment, AI/ML model 430 may be implemented as a neural network model (NNM), a Generalized Linear Model (GLM), a Decision Tree, or another type of learning-based algorithm. According to an exemplary embodiment, the AI/ML model 430 may use an optimization algorithm, such as a reinforcement learning algorithm or another type of learning algorithm (e.g., supervised learning, etc.). The goals of the optimization may be configurable. For example, the optimization may relate to minimization of network congestion, prioritization of end device 102 access to a backup connection, and/or prioritization of traffic. According to other examples, the optimization may relate to a KPI metric (e.g., throughput, bandwidth, delay, etc.) and/or service level agreement (SLA) adherence associated with end device 102 and/or an application service/traffic associated with end device 102. According to some exemplary embodiments, AI/ML model 430 may include algorithms that are not AI/ML-based which may provide, calculate, and/or support one or multiple sub-services for intelligent network segment routing, as described herein.

FIG. 5 is a diagram illustrating an implementation of segment scoring in a simplified network portion 500. Network portion 500 may include forwarding nodes 210-1, 210-2, 210-3, 210-5, and 210-7, with corresponding prefix SIDs 8421, 8422, 8423, 8425, and 8427, respectively. Nodes 210 may be connected via segments 220-1, 220-2, 220-3, 220-4, 220-5, and 220-6. Each of forwarding nodes 210 may be in communication with a link analytics platform 150 that provides real-time scoring for each of segments 220.

As illustrated in FIG. 5, link analytics platform 150 may determine/update a real-time score for each of segments 220. For example, the score of segment 220-1 may correspond to a link utilization value or measured KPI value as determined by AI/ML model 430. In the example of FIG. 5, segment 220-1 may be assigned a real-time score of 65%. Although shown as a percentage value in FIG. 5, in other implementations, the score may be represented as a rank, an integer value, etc. The score for segment 220-1 may be associated, for example, with a SID value that includes the prefix SID of forwarding node 210-1 (i.e., “8421”) and adj-SID of forwarding node 210-2 (i.e., “8422”). Similarly, in the example of FIG. 5, segment 220-2 may be assigned a real-time score of 45%. The score for segment 220-2 may be associated, for example, with a SID value that includes the prefix SID of forwarding node 210-1 (i.e., “8421”) and adj-SID of forwarding node 210-5 (i.e., “8425”).

Routing decisions for forwarding node 210-1 may, thus, be informed by current scores of segments 220-1 and 220-2. In one implementation, link analytics platform 150 may identify a next segment for routing a packet from node 210-1 (i.e., choice between adjacent nodes 210-2 and 210-5) based on the real-time segment scores. In another implementation, link analytics platform 150 may identify and end-to-end path selection through network portion 500, such as from node 210-1 to node 210-3, based on cumulative segment scores. As described further herein, routing paths may, for example, be indicated in packet headers via a listing of the node SIDs.

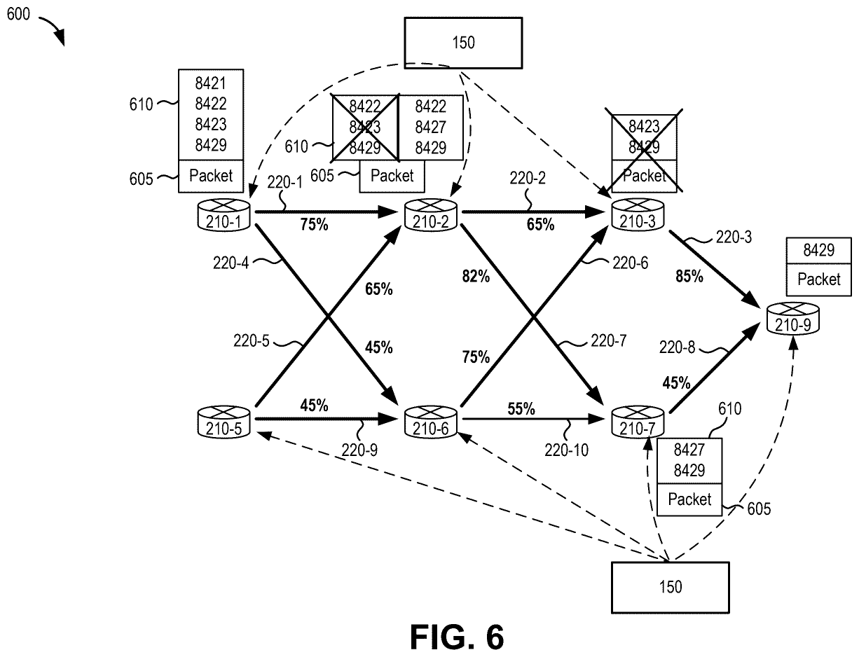

FIG. 6 is a diagram illustrating a routing process based on segment scoring in a network portion 600, according to an implementation. Network portion 600 may include forwarding nodes 210-1, 210-2, 210-3, 210-5, 210-6, 210-7, and 210-9, with corresponding prefix SIDs 8421, 8422, 8423, 8425, 8426, 8427, and 8429, respectfully. Nodes 210 may be connected via segments 220-1, 220-2, 220-3, 220-4, 220-5, 220-6, 220-7, 220-8, 220-9, and 220-10. Each of forwarding nodes 210 may be in communication with a link analytics platform 150 that provides real-time scoring for each of segments 220.

Assume a packet 605 needs to be routed from node 210-1 (prefix SID 8421) to node 210-9 (prefix SID 8429). Link analytics platform 150 may identify an initial recommended routing path for the packet through forwarding nodes 210-1, 210-2, 210-3, and 210-9 and inform forwarding node 210-1. Forwarding node 210-1 may indicate the path through individual network segments 220 via a packet header 610 with a sequential list of prefix SIDs (i.e., 8422, 8423, and 8429). Forwarding node 210-1 may route the packet to the next hop, node 210-2, via segment 220-1.

Node 210-2 may receive packet 605. Node 210-2 may determine that segment 220-2 is blocked or interrupted. Based on the path scores of segments 220-2 and 220-7 (e.g., as provided by link analytics platform 150), node 210-2 may determine that segment 220-7 is a better (e.g., higher scored) segment to relay packet 605. Accordingly, node 210-2 may change the routing path in header 610 to a sequential list of prefix SIDs that includes node 210-7, instead of node 210-3 (i.e., 8427, and 8429). Forwarding node 210-2 may then route the packet 605 to the next hop, node 210-7, via segment 220-7. Node 210-7 may receive packet 605, update header 610 to include only the prefix SID for the last hop node 210-9. Accordingly, packet 605 may be routed through network portion 600 based on a best segment score at each node 210 and account for a segment interruption (e.g., due to fiber cut or other network problem) without dropping packet 605.

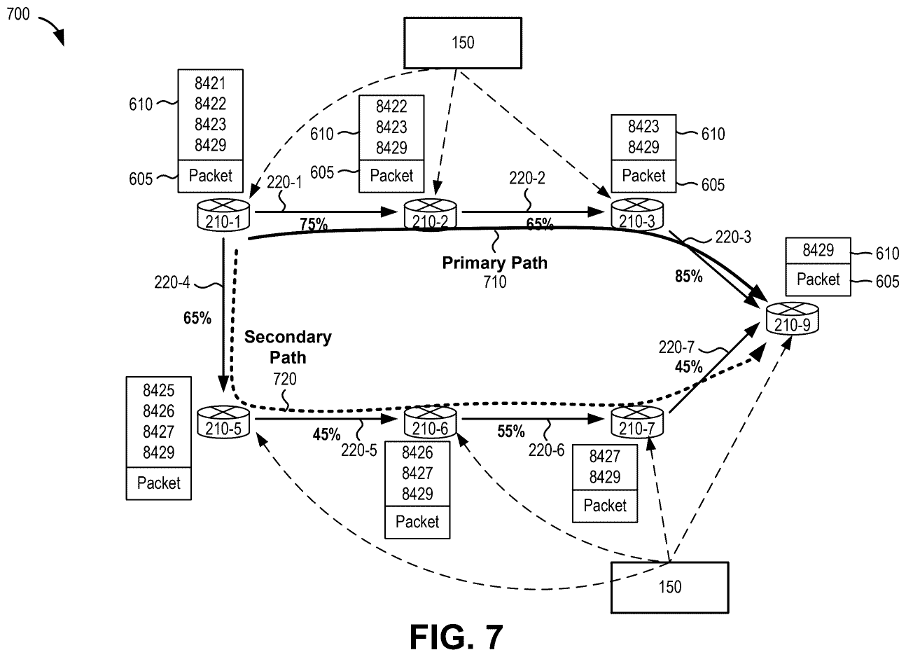

FIG. 7 is a diagram illustrating a path determining process based on path scoring in network portion 700, according to an implementation. Network portion 700 may include forwarding nodes 210-1, 210-2, 210-3, 210-5, 210-6, 210-7, and 210-9, with corresponding prefix SIDs 8421, 8422, 8423, 8425, 8426, 8427, and 8429. Nodes 210 may be connected via segments 220-1, 220-2, 220-3, 220-5, 220-6, and 220-7. Each of forwarding nodes 210 may be in communication with a link analytics platform 150 that provides real-time scoring for each of segments 220.

Assume a packet 605 needs to be routed from node 210-1 (prefix SID 8421) to node 210-9 (prefix SID 8429). Based on real-time segment scores in network portion 700, link analytics platform 150 may identify a recommended primary routing path 710 for the packet through forwarding nodes 210-1, 210-2, 210-3, and 210-9. Forwarding node 210-1 may indicate the primary path through individual network segments 220 via a packet header 610 with a sequential list of prefix SIDs (i.e., 8422, 8423, and 8429). The primary path 710 may be selected based on, for example, an aggregate score of the segments 220-1, 220-2, and 220-3. Based on real-time segment scores in network portion 700, link analytics platform 150 may also identify a secondary routing path 720 for the packet through forwarding nodes 210-1, 210-5, 210-6, 210-7, and 210-9. The secondary path 720 may be selected based on, for example, an aggregate score of the segments 220-4, 220-5, 220-6, and 220-7. In the event of an interruption to primary path 710, forwarding node 210-1 may switch routing of packet 605 to secondary path 720 by modifying packet header 610 with a sequential list of prefix SIDs for the secondary path (i.e., 8425, 8426, 8427, and 8429). Accordingly, packet 605 may be routed through network portion 700 based on a best overall path score and account for a segment interruption without dropping packet 605.

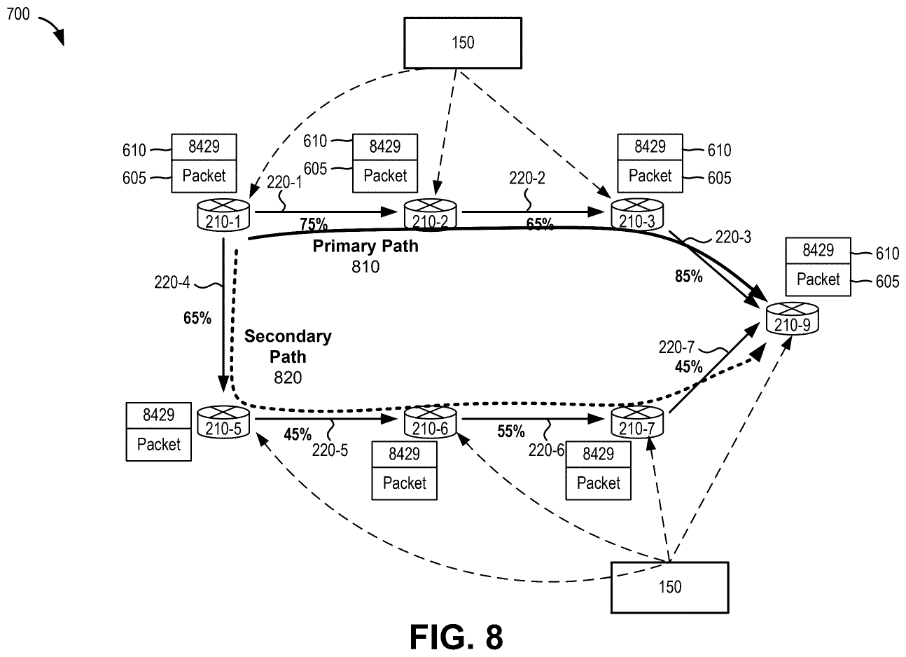

FIG. 8 is a diagram illustrating a prefix-based routing process based on segment scoring in network portion 700, according to another implementation. Assume a packet 605 needs to be routed from node 210-1 (prefix SID 8421) to node 210-9 (prefix SID 8429). Based on real-time segment scores in network portion 700, link analytics platform 150 may identify a recommended primary routing path 810 for the packet through forwarding nodes 210-1, 210-2, 210-3, and 210-9. However, in contrast with the example of FIG. 7, header 610 for packet 605 may include only the prefix SID of the path endpoint (e.g., prefix SID 8429 for node 210-9). Each node 210 along the primary path 810 may receive the primary path routing to enable forwarding of packet 605. In the event of an interruption to primary path 810, forwarding node 210-1 may switch routing of packet 605 to secondary path 820. However, no modification of header 610 is needed as each node 210 along the secondary path 820 may receive the secondary path routing to enable forwarding of packet 605. Accordingly, packet 605 may be routed through network portion 700 based on a best overall path score and account for a segment interruption without dropping packet 605.

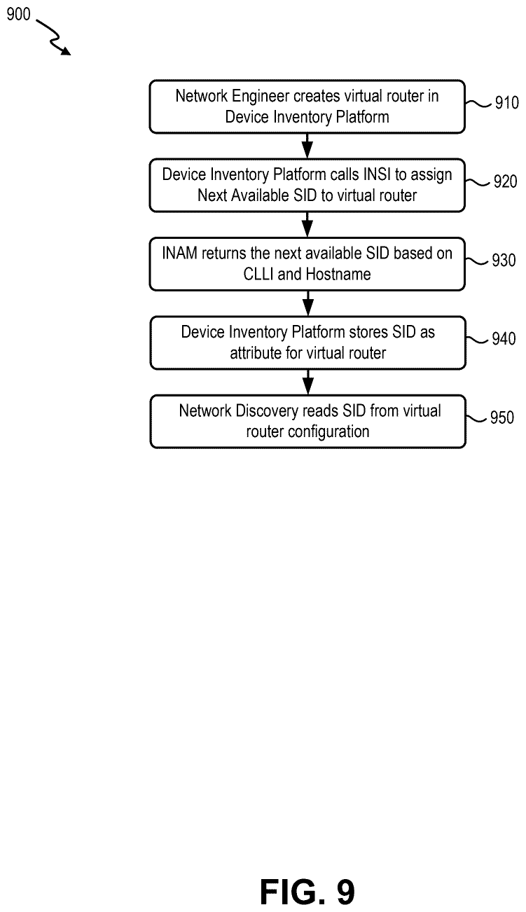

FIG. 9 is a flow diagram illustrating an exemplary process 900 for configuring a node for intelligent segment routing. Process 900 may include creating a virtual router in a device inventory platform (block 910). For example, a network engineer may configure a virtual node 210, such as an Evolved Network Services Edge (eNSE) router or another network node 210 in a virtual RAN, using device inventory platform 310.

Process 900 may further include assigning a next available SID to the virtual router (block 920). For example, device inventory platform 310 may send an API call to INSI 320 to obtain a next available SID for the virtual router.

Process 900 may further include returning the next available SID to the device inventory platform based on a Common Language Location Identification (CLLI) code and/or hostname (block 930). For example, a SRGB (e.g., SRGB 304) may include a block of available SIDs for virtual network elements in a network portion. INSI 320 may assign a next available prefix SID from the block of available SIDs.

Process 900 may additionally include storing the SID as an attribute for the virtual router (block 940) and reading the SID during network discovery (block 950). For example, device inventory platform 310 may receive the next available SID and store the SID in prefix SID field 308 of data structure 306. Link analytics platform 150 (e.g., network discovery 420) may associate the prefix SID with the virtual node and assign a real-time segment score and/or recommended routing path that includes the prefix SID.

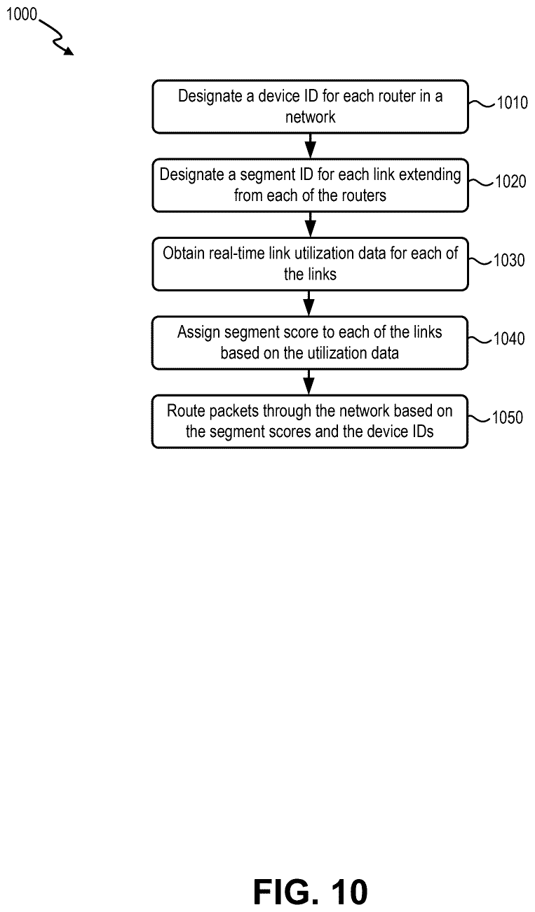

FIG. 10 is a flow diagram illustrating an exemplary process 1000 for performing intelligent network segment routing. Process 1000 may be performed, for example, by provisioning platform 140 and devices in inter intermediary network 120. In another implementation, process 1000 may be performed by provisioning platform 140, devices in intermediary network 120, and link analytics platform 150.

Process 1000 may include designating a node or device ID for each virtual router in a network (block 1010) and designating a segment ID for each link extending from each of the routers (block 1020). For example, an eNSE router or another network node 210 in a virtual RAN, may be configured using device inventory platform 310. Device inventory platform 310 may send an API call to INSI 320 to obtain a next available SID for the virtual router, and device inventory platform 310 may store the SID in prefix SID field 308 of data structure 306. Segment IDs may be defined using the segment ID for each monitored segment 220 (e.g., including a prefix SID and an adj-SID at each link endpoint).

Process 1000 may further include obtaining real-time link utilization data for each of the links (block 1030) and assigning a segment score to each of the links based on the utilization data (block 1040). For example, link analytics platform 150 may collect real-time link utilization data for links 220 in a network portion. Network discovery system 420, for example, may collect, among other parameters, a segment ID, utilization level, path bandwidth, a quality of network, throughput, and power (e.g., signal power used) for nodes 210. Link analytics platform 150 may determine a real-time score for each of segments 220 based on the collected parameters. For example, the score of segment 220-1 may correspond to a link utilization value or measured KPI value as determined by AI/ML model 430.

Process 1000 may also include routing packets through the network based on the segment scores and the node IDs (block 1050). For example, as described above in connection with FIGS. 5-8, link analytics platform 150 may apply segment and/or path scores to determine a sequence of nodes to navigate a packet from end-to-end. In one implementation, the packets may include a header with routing labels using the prefix SID of each node on a path. In another implementation, the packets may include a header with routing labels using the prefix SID of a last node on a path.

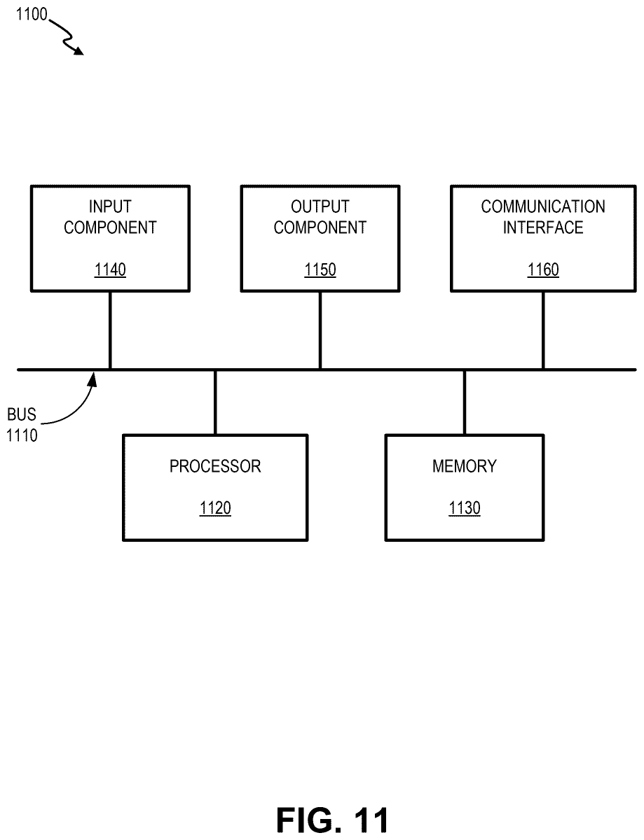

FIG. 11 illustrates example components of a device 1100 according to an implementation described herein. UE device 102, wireless access station 108, provisioning platform 140, link analytics platform 150, and other devices in environment 100 may each include one or more devices 1100. Device 1100 may include a bus 1110, a processor 1120, a memory 1130, an input component 1140, an output component 1150, and a communication interface 1160.

Bus 1110 may include a path that permits communication among the components of device 1100. Processor 1120 may include a processor, a microprocessor, or processing logic that may interpret and execute instructions. Memory 1130 may include any type of dynamic storage device that stores information and instructions, for execution by processor 1120, and/or any type of non-volatile storage device that stores information for use by processor 1120. Input component 1140 may include a mechanism that permits a user to input information to device 1100, such as a keyboard, a keypad, a button, a switch, etc. Output component 1150 may include a mechanism that outputs information to the user, such as a display, a speaker, one or more light emitting diodes (LEDs), etc.

Communication interface 1160 may include a transceiver that enables device 1100 to communicate with other devices and/or systems via wireless communications, wired communications, or a combination of wireless and wired communications. For example, communication interface 1160 may include mechanisms for communicating with another device or system via a network. Communication interface 1160 may include an antenna assembly for transmission and/or reception of RF signals. For example, communication interface 1160 may include one or more antennas to transmit and/or receive RF signals over the air. In one implementation, for example, communication interface 1160 may communicate with a network and/or devices connected to a network. Alternatively, or additionally, communication interface 1160 may be a logical component that includes input and output ports, input and output systems, and/or other input and output components that facilitate the transmission of data to other devices.

Device 1100 may perform certain operations in response to processor 1120 executing software instructions contained in a computer-readable medium, such as memory 1130. A computer-readable medium may be defined as a non-transitory memory device. A memory device may include a single physical memory device or multiple physical memory devices. The software instructions may be read into memory 1130 from another computer-readable medium or from another device. When executed by processor 1120, the software instructions contained in memory 1130 may cause processor 1120 to perform processes described herein. Alternatively, hardwired circuitry may be used in place of or in combination with software instructions to implement processes described herein. Thus, implementations described herein are not limited to any specific combination of hardware circuitry and software.

Although FIG. 11 shows exemplary components of device 1100, in other implementations, device 1100 may contain fewer components, additional components, different components, or differently arranged components than those depicted in FIG. 11. Additionally, or alternatively, one or more components of device 1100 may perform one or more tasks described as being performed by one or more other components of device 1100.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustrations but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of communications have been described with regard to FIGS. 5-8, and series of blocks have been described with regard to the processes illustrated in FIGS. 9 and 10, the order of the communications and blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 1120) of a device. A non-transitory storage medium includes one or more of the storage mediums described in relation to memory/storage 1130. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
designating a unique node identifier (ID) for each routing node in a network;
designating a segment ID for each link between two of the routing nodes, wherein each segment ID is based on a first node ID and an adjacent second node ID for each link;
obtaining real-time link utilization data for each of the links;
assigning a segment score to each of the links based on the real-time link utilization data and the segment ID; and
routing packets through the network based on the segment scores and the node IDs.

2. The method of claim 1, wherein routing packets through the network includes:
selecting a routing path based on an aggregate of the segment scores between end points; and
generating a packet header including a routing label with a list of node IDs of each node in the routing path.

3. The method of claim 1, wherein routing packets through the network includes:
generating a packet header including a node ID of only an end node in a routing path.

4. The method of claim 1, wherein assigning a segment score to each of the links includes:
applying one or more of a regression algorithm, a classification model, or a trend analysis model to the real-time link utilization data.

5. The method of claim 1, wherein each routing node includes a virtual routing instance configured using software-defined networking (SDN).

6. The method of claim 1, wherein obtaining the real-time link utilization data includes obtaining one or more of:
the segment ID,
a path bandwidth, or
a throughput.

7. The method of claim 1, wherein obtaining the real-time link utilization data includes obtaining one or more of:
a quality of network measurement, or
a power measurement.

8. The method of claim 1, wherein routing packets through the network includes:
detecting an interruption in a primary routing path for a packet, and
rerouting the packet via a secondary routing path without dropping the packet, wherein rerouting includes modifying a header of the packet to include a routing label with a node ID of each node on the secondary routing path.

9. A system comprising:
one or more first network devices including a first processor configured to:
designate a unique node identifier (ID) for each routing node in a network, and
designate a segment ID for each link between two of the routing nodes, wherein each segment ID is based on a first node ID and an adjacent second node ID for each link;
one or more second network devices including a second processor configured to:
obtain real-time link utilization data for each of the links, and
assign a segment score to each of the links based on the real-time link utilization data and the segment ID; and
one or more third network devices including a third processor configured to:
route packets through the network based on the segment scores and the node IDs.

10. The system of claim 9, wherein, when routing the packets, the third processor is further configured to:
select a routing path based on an aggregate of the segment scores between end points.

11. The system of claim 9, wherein, when routing the packets, the third processor is further configured to:
generate a packet header including a routing label with a list of node IDs of each node in a routing path.

12. The system of claim 9, when routing the packets, the third processor is further configured to:
generate a packet header including a routing label with a node ID of only an end node in a routing path.

13. The system of claim 9, wherein the second network device includes an artificial intelligence/machine learning (AI/ML) system, and wherein, when assigning a segment sore, the second processor applies one or more of a regression algorithm, a classification model, or a trend analysis model to the real-time link utilization data.

14. The system of claim 9, wherein the one or more third network devices includes a virtual routing instance configured using software-defined networking (SDN).

15. The system of claim 9, wherein, when obtaining the real-time link utilization data, the second processor is further configured to:
obtain one or more of a path bandwidth or a power measurement.

16. The system of claim 9, wherein, when routing packets through the network, the third processor is further configured to:
detect an interruption in a primary routing path for a packet, and
reroute the packet via a secondary routing path without dropping the packet, wherein rerouting includes modifying a header of the packet to include a routing label with a node ID of each node on the secondary routing path.

17. A non-transitory, computer-readable storage medium storing instructions, executable by one or more processors of a network device, for:
designating a unique node identifier (ID) for each routing node in a network;
designating a segment ID for each link between two of the routing nodes, wherein each segment ID is based on a first node ID and an adjacent second node ID for each link;
obtaining real-time link utilization data for each of the links;
assigning a segment score to each of the links based on the real-time link utilization data and the segment ID; and
routing packets through the network based on the segment scores and the node IDs.

18. The non-transitory, computer-readable storage medium of claim 17, wherein the instructions for routing packets through the network include instructions for:
selecting a routing path based on an aggregate of the segment scores between end points.

19. The non-transitory, computer-readable storage medium of claim 17, wherein the instructions for assigning a segment score to each of the links includes instructions for:
applying one or more of a regression algorithm, a classification model, or a trend analysis model to the real-time link utilization data.

20. The non-transitory, computer-readable storage medium of claim 17, wherein the instructions for routing packets through the network further include instructions for:
detecting an interruption in a primary routing path for a packet, and
rerouting the packet via a secondary routing path without dropping the packet.
